(19) United States
(12) Patent Application Publication
(10) Pub. No.: US 2006/0160558 A1
(43) Pub. Date: Jul. 20, 2006

(54) Method and apparatus for transition of operation mode in a wireless communication system

(75) Inventors: Sa-Jin Kim, Yongin-si (KR); Jeong-Hoon Park, Yongin-si (KR); Kang-Gyu Lee, Yongin-si (KR); Yun-Sung Kim, Yongin-si (KR); Eun-Jeong Ahn, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/335,290

(22) Filed: Jan. 19, 2006

(30) Foreign Application Priority Data
Jan. 19, 2005 (KR) 5167-2005

(51) Int. Cl. H04B 7/00

(52) U.S. Cl. 455/522

(57) ABSTRACT

A method is provided for reducing power consumption of a mobile station (MS) in a wireless communication system. If a period of time for state transition from a normal mode to a sleep mode or an idle mode expires, the MS transmits a request message for state transition to a corresponding operation mode to a base station (BS) with which the MS is currently communicating. Upon receiving a response message to the request message, the MS performs a state transition to the sleep mode or the idle mode. Upon detecting a change in service area in the sleep mode, the MS performs a state transition to the normal mode. Upon receiving a paging advertisement message from a corresponding BS in the idle mode, the MS performs a state transition to the normal mode.

### PRIORITY

This application claims the benefit under 35 U.S.C. § 119(a) of an application entitled “Method and Apparatus for Transition of Operation Mode in a Wireless Communication System” filed in the Korean Intellectual Property Office on Jan. 19, 2005 and assigned Serial No. 2005-5167, the contents of which are incorporated herein by reference.

### BACKGROUND OF THE INVENTION

1. Field of the Invention

The present invention relates generally to a wireless communication system, and in particular, to an operation mode support technology for saving power of a mobile station (MS) in a wireless communication system.

2. Description of the Related Art

In general, when mobility of a subscriber station (SS) is taken into consideration in a wireless communication system, power consumption of the SS serves as an important factor of the entire system. Therefore, reducing power consumption of the SS supporting the mobility in the wireless communication system is of great importance. In the following description, the SS supporting the mobility will be referred to as a “mobile station (MS).”

A sleep mode operation or an idle mode operation between an MS and a base station (BS) has been proposed as a method for minimizing power consumption of the MS.

In the sleep mode or the idle mode of operation, the MS stops all functions, such as transmission and reception, except for a real time clock (RTC) and a phase locked loop (PLL). At this time, the PLL for reactivation of the MS is in an active state. Further, in the sleep mode or the idle mode, the MS periodically awakes to perform search and ranging for neighbor BSs, or handover. Generally, the wireless communication system can reduce power consumption of the MS using the sleep mode or the idle mode.

A brief description of the sleep mode will now be given. The sleep mode has been proposed to minimize power consumption of an MS in an idle interval occurring during packet data transmission. Commonly, in an Institute of Electrical and Electronics Engineers (IEEE) 802.16a system, there was no need to take the sleep mode into account because the SS fixed to a particular location can be easily provided with power supply. However, an IEEE 802.16e system, which takes mobility of the SS into account, requires the sleep mode because the SS (or MS) unfixed to a particular location cannot be easily provided with power supply.

That is, the sleep mode minimizes power consumption of the MS in an interval where no packet data is transmitted. Because the packet data is commonly generated on a burst basis, it is unreasonable for the MS to operate in the same fashion both when no packet data is transmitted and when packet data is transmitted. The sleep mode has been proposed to solve this problem.

The MS, if it enters the sleep mode, experiences a sleep window (or sleep interval) and a listening window (or listening interval).

The sleep window represents an interval that can be requested by an MS and then allocated by a BS in response to the request. The sleep window represents a time interval from the time when the MS makes a state transition to the sleep mode to the time when the MS makes a state transition back to an awake mode. As a result, the sleep window is defined as a time for which the MS stays in the sleep mode.

The MS may continue to stay in the sleep mode even after the sleep window. In this case, the MS updates the sleep window by performing an exponentially increasing algorithm using minimum and maximum window values. That is, the MS preferably stays in the sleep mode for a time indicated by the minimum window value in a first sleep window, and if there is no data to transmit even after a lapse of the time, the MS exponentially increases the sleep window. To prevent the sleep window from indefinitely increasing, when the sleep window reaches its maximum window, the MS may continue to hold the maximum window value or may return the sleep window back to the minimum window value.

Herein, the minimum window value represents a minimum value of the sleep window, and the maximum window value represents a maximum value of the sleep window. Both values are expressed in the number of frames, and are allocated by a BS.

The listening window represents an interval that can be requested by an MS and then allocated by a BS in response to the request. In other words, the listening window represents a time interval from the time when the MS awakes from the sleep mode to the time when the MS can decode downlink (DL) messages, such as a traffic indication (MOB-TRF-IND) message, in sync with a downlink signal from the BS. The MOB-TRF-IND message indicates the presence of traffic, i.e., packet data, to be transmitted to the MS. The MS determines whether to hold the awake mode or transition back to the sleep mode depending on a value of the MOB-TRF-IND message.

The MS can stop transmission and reception of data during a frame corresponding to the sleep interval, thereby reducing its power consumption. In some cases, the MS can return to the awake mode to perform periodic ranging. Upon entering the listening window, the MS must awake because it should decode a MOB-TRF-IND message transmitted from the BS to determine whether there is downlink traffic allocated thereto. That is, the MS must make a state transition from the sleep mode to the awake mode and return to the state where it can receive the traffic.

FIG. 1 is a signaling diagram illustrating a sleep mode procedure of an MS in a conventional wireless communication system.

Referring to FIG. 1, an MS 100 transmits a Sleep Request (MOB-SLP-REQ) message to a BS 150 to request its entry into the sleep mode in step 101. The MOB-SLP-REQ message is transmitted from an MS to a BS and used by the MS to request state transition to the sleep mode. The MOB-SLP-REQ message includes information elements (IEs) required by the MS to operate in the sleep mode.

Upon receiving the MOB-SLP-REQ message, the BS 150 transmits a Sleep Response (MOB-SLP-RSP) message to the MS 100 in response to the MOB-SLP-REQ message to indicate approval/denial for the request for the entry into the sleep mode in step 103. The MOB-SLP-RSP message can be used to indicate whether to approve or deny the state transition to the sleep mode, requested by the MS, or to indicate an unsolicited instruction. The term “unsolicited instruction” refers to an operation of allowing an MS to operate in response to an instruction, i.e., a control signal, from a BS, without any separate request from the MS. The MOB-SLP-RSP message includes IEs required by the MS to operate in the sleep mode.

Upon receiving the MOB-SLP-RSP message from the BS 150, the MS 100 enters the sleep mode in response thereto. That is, the MS 100 analyzes a Sleep Approved value included in the MOB-SLP-RSP message, and makes a state transition to the sleep mode if the Sleep Approved value indicates approval for state transition to the sleep mode. In this case, the MS 100 repeatedly experiences sleep windows 105 and 111 and listening windows 107 and 113.

Thereafter, in step 109 or 115, the BS 150 transmits to the MS 100 a MOB-TRF-IND message indicating the presence of an MS-related message and downlink traffic buffered in the BS 150, in the listening window 107 or 113 of the MS 100 according to a sleep mode pattern negotiated through the MOB-SLP-REQ message and the MOB-SLP-RSP message. Preferably, the BS 150 transmits a DL-MAP to the MS 100 before transmitting the MOB-TRF-IND message in the listening windows 107 and 113. The DL-MAP describes a reception interval in a time interval for each MS, and each MS can determine the time interval where it will receive data, depending on the DL-MAP.

A brief description of the idle mode will now be given below. An MS transmits a De-registration Request (DREG-REQ) message to a BS to request its entry into the idle mode. The DREG-REQ message is transmitted from the MS to the BS and used by the MS to request state transition to the idle mode. The DREG-REQ message includes IEs required by the MS to operate in the idle mode. A format of the DREG-REQ message is shown in Table 1 below.

TABLE 1

| Syntax | Size | Notes |
|---|---|---|
| DREG-REQ_Message_Format( ) { | | |
| Management message Type = 49 | 8 bits | |
| De-registration_Request_Code | 8 bits | 0x00 = MS de- |
| | | registration request |
| | | from BS and network |
| | | 0x01 = request for |
| | | MS de-registration |
| | | from Serving BS and |
| | | initiation of MS Idle |
| | | Mode |
| | | 0x02-0xFF = |
| | | Reserved |
| TLV encoded parameters | Variable | |
| } | | |

| Name | Type | Length | Value |
|---|---|---|---|
| Paging Cycle Request | | 2 | Requested Cycle in which |
| | | | the paging message is |
| | | | transmitted within the |
| | | | paging group |

As shown in Table 1, a 16-bit Paging Cycle requested by an MS is defined in the DREG-REQ message.

Upon receiving the DREG-REQ message from the MS, the BS transmits a De-registration Command (DREG-CMD) message to the corresponding MS in response to the DREG-REQ message. The DREG-CMD message is used as a message indicating a response to the MS's request for the state transition to the idle mode. A format of the DREG-CMD message is shown in Table 2 below.

TABLE 2

| Syntax | Size | Notes |
|---|---|---|
| DREG-CMD_Message_Format( ) { | | |

| | |
|---|---|
| Management Message Type = 29 | 8 bits |
| Action Code | 8 bits |
| TLV encoded parameters | Variable |
| } | |

| Name | Type | Length | Value |
|---|---|---|---|
| Paging | | 4 | Bits 15:0 - PAGING_CYCLE - Cycle |
| Information | | | in which the paging message is |
| | | | transmitted within the paging |
| | | | group |
| | | | Bits 23:16 - PAGING OFFSET - |
| | | | Determines the frame within the |
| | | | cycle in which the paging message |
| | | | is transmitted. |
| | | | Must be smaller than PAGING CYCLE |
| | | | value |
| | | | Bits 31:24 - Paging-group-ID - ID |
| | | | of the paging group the MS is |
| | | | assigned to |
| REQ-Duration | | 1 | Waiting value for the DREG-REQ |
| | | | message retransmission (measured |
| | | | in frames) |
| Paging | | 6 | This is a logical network |
| Controller ID | | | identifier for the Serving BS or |
| | | | other network entry remaining MS |
| | | | service and operational |
| | | | information and/or administering |
| | | | paging activity for the MS while |
| | | | in IDLE Mode |

The DREG-CMD message shown in Table 2 is transmitted by a BS in response to the DREG-REQ message shown in Table 1 from the MS. The DREG-CMD message includes an 8-bit Paging Group Identifier (ID), an 8-bit Paging Offset, and a 16-bit Paging Cycle defined therein.

The MS enters the idle mode upon receipt of the DREG-CMD message from the BS. Specifically, upon receiving the DREG-CMD message from the BS, the MS receives a Paging Advertisement (MOB-PAG-ADV) message transmitted from the BS for a paging interval defined as a predetermined number of, for example, 5 fames in which a frame number (FN) for a channel in sync with its current BS satisfies a predetermined condition. For example, the predetermined condition can be represented by FN/Paging Cycle=Paging Offset. The MOB-PAG-ADV message includes a Paging Group ID to which a BS that transmits the MOB-PAG-ADV message belongs, Medium Access Control (MAC) address Hash information indicating MSs that require location update or initial network entry among the MSs operating in the idle mode, and an Action Code describing a procedure that should be performed for each individual MS.

In the foregoing wireless communication system, the sleep mode and the idle mode are independently described. In addition, the conventional technology merely gives a definition of the sleep mode and the idle mode, and does not specifically describe in which situation the MS should enter the sleep mode or the idle mode.

That is, in a system implementation process, only the sleep mode or the idle mode can independently operate. However, there is a need for an efficient transition method from the sleep mode to the idle mode in order for the two modes to simultaneously exit and to optimally cooperate with each other.

### SUMMARY OF THE INVENTION

It is, therefore, an object of the present invention to provide an operation mode transition method and apparatus for allowing a sleep mode and an idle mode of an MS to optimally co-operate with each other in a wireless communication system.

It is another object of the present invention to provide a scheme capable of supporting a low-power mode of an MS in a wireless communication system.

It is further another object of the present invention to provide an operation mode support scheme capable of reducing power consumption of an MS in a wireless communication system.

It is yet another object of the present invention to provide an apparatus and method for reducing power consumption of an MS through a condition for state transition from a sleep mode to an idle mode and a cooperation scheme for the modes based thereon in a wireless communication system.

According to the present invention, there is provided a method for reducing power consumption of a mobile station (MS) in a wireless communication system. The method includes, if a time for state transition from a normal mode to a sleep mode or an idle mode expires, transmitting a request message for state transition to a corresponding operation mode to a base station (BS) with which the MS is currently communicating, upon receiving a response message to the request message, performing a state transition to the sleep mode or the idle mode, upon detecting a change in service area in the sleep mode, performing a state transition to the normal mode, and upon receiving a paging advertisement message from a corresponding BS in the idle mode, performing a state transition to the normal mode.

According to the present invention, there is also provided an apparatus for controlling an operation mode of a mobile station (MS) in a wireless communication system. The apparatus includes a base station (BS) switching detector for receiving a control message from a particular BS in a listening window for a sleep mode, and detecting whether a BS's service area of the MS is switched, based on the received control message, and an operation mode controller for checking whether any traffic is generated after performing a state transition from the sleep mode to a normal mode according to the BS switching detection result, and performing a state transition to an idle mode or the sleep mode if no traffic is generated for a period of time.

According to the present invention, there is further provided a method for performing a transition of an operation mode in a mobile station (MS) in a wireless communication system. The method includes detecting whether a service area is switched, based on a control message received in a listening window for a sleep mode, performing a state transition to a normal mode after releasing the sleep mode if the service area is switched, and performing a state transition to an idle mode or the sleep mode if no traffic is generated in the normal mode for a period of time.

According to the present invention, there is provided a method for reducing power consumption of a mobile station (MS) in a wireless communication system. The method includes receiving a downlink MAP (DL-MAP) from a particular base station (BS), performing a state transition to a normal mode after releasing a current mode if the MS determines that it has moved to coverage of another BS, and entering a low-power mode if no traffic is generated in the normal mode for a period of time.

According to the present invention, there is provided an apparatus for reducing power consumption of a mobile station (MS) in a wireless communication system. The apparatus includes a receiver for receiving a downlink MAP (DL-MAP) transmitted from a particular base station (BS), and a controller for performing a state transition to a normal mode after releasing a current mode if the MS determines from the DL-MAP that it has moved to coverage of another BS, and entering a low-power mode if no traffic is generated for a period of time.

### BRIEF DESCRIPTION OF THE DRAWINGS

The above and other objects, features and advantages of the present invention will become more apparent from the following detailed description when taken in conjunction with the accompanying drawings in which:

FIG. 1 is a signaling diagram illustrating a sleep mode procedure of an MS in a conventional wireless communication system;

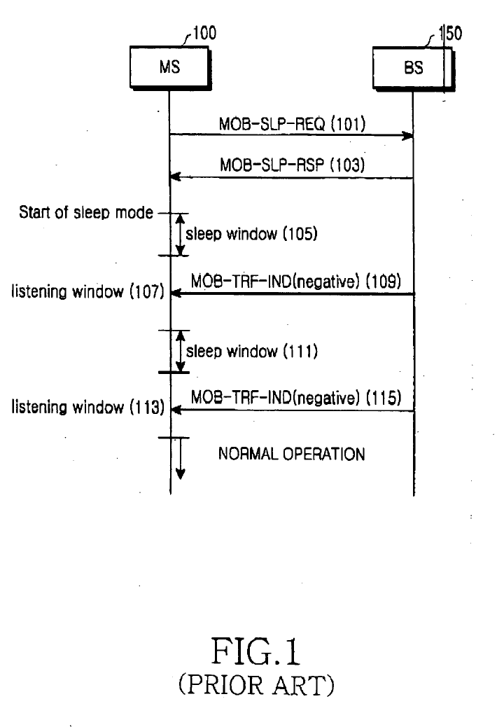

FIG. 2 is a diagram illustrating a method for operating a sleep mode and an idle mode by an MS in a wireless communication system according to the present invention;

FIG. 3 is a diagram illustrating a signaling process between an MS and a BS in a wireless communication system according to the present invention;

FIG. 4 is a block diagram schematically illustrating a structure of an MS according to the present invention;

FIG. 5 is a flowchart illustrating a process of controlling an operation mode in a MS in a wireless communication system according to the present invention; and

FIG. 6 is a diagram illustrating a state transition process of an MS in a wireless communication system according to the present invention.

### DETAILED DESCRIPTION OF THE PREFERRED EMBODIMENTS

Preferred embodiments of the present invention will now be described in detail with reference to the annexed drawings. In the following description, a detailed description of known functions and configurations incorporated herein has been omitted for purposes of clarity and conciseness.

The present invention provides an apparatus and method for supporting a low-power mode of a mobile station (MS) in a wireless communication system. In particular, the present invention provides a condition for state transition from a sleep mode to an idle mode and a cooperation scheme for the modes based thereon to reduce power consumption of an MS. That is, the present invention supports a power-saving operation mode of an MS in a wireless communication system.

According to the present invention, upon entering the sleep mode, an MS checks base station (BS) information in a first frame of every listening window succeeding a sleep window. Specifically, upon entering the sleep mode, the MS checks BS information in a first frame of a first listening window appearing after the sleep window. That is, the MS compares a frame number (FN) and/or BS-ID information defined in the current downlink MAP (DL-MAP) with an expected FN calculated after transition to the sleep mode and/or BS-ID information immediately before the transition to the sleep mode.

When the MS is already operating in the sleep mode, it compares an FN and/or BS-ID information defined in the current DL-MAP with an expected FN calculated based on an FN defined in a DL-MAP received at a previous listening window and/or BS-ID information.

If an FN and/or BS-ID information defined in the current DL-MAP is different from an expected FN and/or BS-ID information immediately before the transition to the sleep mode, the MS determines that it has moved to coverage of another BS for the sleep window. In this case, therefore, the MS transitions to a normal mode after releasing the sleep mode. After the transition to the normal mode, the MS checks an uplink/downlink (UL/DL) traffic activity to determine whether traffic has been generated for a period of time.

Upon detecting the generation of the traffic activity in this process, the MS performs a normal service procedure for processing the traffic generated in the normal mode. However, if it is determined that the traffic activity is not continuously generated for a period of time following the sleep mode in the foregoing process, the MS enters a low-power mode, such as the sleep mode or the idle mode, for reducing power consumption.

For example, according to the present invention, in order to enter the idle mode out of the low-power modes, the MS transmits a De-registration Request (DREG-REQ) message with a Paging Cycle value to a BS. Upon receiving the DREG-REQ message, the BS delivers information on an idle mode pattern that the MS should use, to the corresponding MS through a De-registration Command (DREG-CMD) message in response to the DREG-REQ message, using a Paging Group ID, a Paging Cycle and a Paging Offset. Upon receiving the DREG-CMD message, the MS operates the idle mode based on the corresponding information.

According to the present invention, the MS also transmits a Sleep Request (MOB-SLP-REQ) message to the BS in order to enter the sleep mode out of the low-power modes. Upon receiving the MOB-SLP-REQ message, the BS transmits a Sleep Response (MOB-SLP-RSP) message indicating approval/denial for the MS's request for the entry into the sleep mode. Upon receiving the MOB-SLP-RSP message from the BS, the MS enters the sleep mode.

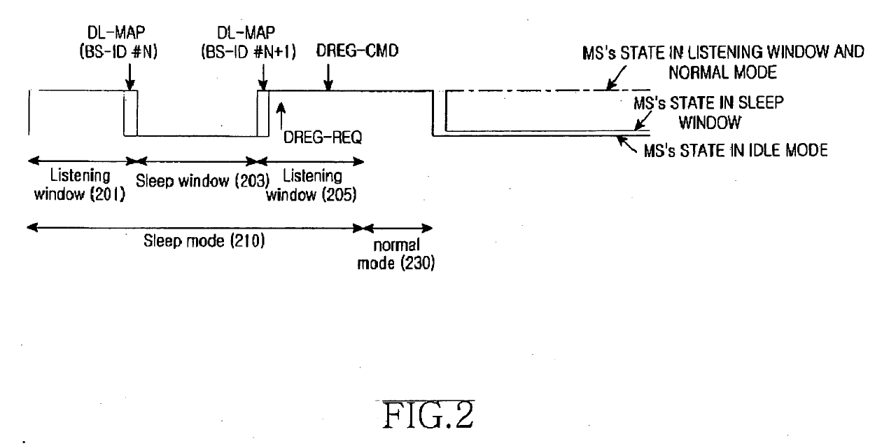

FIG. 2 is a diagram illustrating a preferred method for operating a sleep mode and an idle mode by an MS in a wireless communication system according to the present invention.

Before a description of FIG. 2 is given, it will be assumed in FIG. 2 that an MS moves from a service area formed by a BS currently providing a service thereto, such as a serving BS, to a service area formed by a BS scheduled to later provide a service thereto, such as a target BS, generating handover.

That is, it will be assumed in FIG. 2 that the MS exists in, for example, a sleep window 203 for the sleep mode while performing handover from the serving BS to the target BS. In this state, the MS stops communication with the serving BS and the target BS, as it remains in the sleep mode. Therefore, the MS cannot be aware that it has moved from the service area formed by the service BS to the service area formed by the target BS.

Referring to FIG. 2, if the MS receives a first frame from a BS in every listening window, such as a listening window 201 or a listening window 205 occurring before or after a sleep window 203, it checks BS information in the first frame. For example, the MS checks an FN and/or BS-ID information defined in a DL-MAP of the first frame received in the listening window 205 following the sleep window 203, and compares the check result with an expected FN calculated based on the previous listening window 201 and/or BS-ID information.

Particularly, in FIG. 2, the MS compares an expected FN and/or BS-ID#N information defined in a DL-MAP received in the previous listening window 201 with an FN and/or BS-ID#(N+1) information defined in a DL-MAP received in the current listening window 205. If the compared information is different, the MS transitions to the normal mode after releasing the sleep mode, considering that it has moved to coverage of another BS for the sleep window.

After the transition to the normal mode, the MS checks a UL/DL traffic activity to determine whether any traffic activity has been generated for a period of time. If no traffic activity has been generated for a period of time following the sleep mode 203, the MS enters the low-power mode, such as the idle mode or the sleep mode.

As shown in FIG. 2, the MS transmits a DREG-REQ message with a Paging Cycle value to the BS in order to enter the idle mode out of the low-power modes. Upon receiving the DREG-REQ message, the BS transmits information on an idle mode pattern that the MS should use, through a DREG-CMD message in response to the DREG-REQ message. That is, the BS delivers the information on the idle mode pattern to the MS using a Paging Group ID, a Paging Cycle, and a Paging Offset. Upon receiving the DREG-CMD message, the MS operates the idle mode based on the corresponding information.

Alternatively, the MS transmits a MOB-SLP-REQ message to the BS in order to enter the sleep mode out of the low-power modes. Upon receiving the MOB-SLP-REQ message, the BS transmits information indicating approval/denial for the MS's entry into the sleep mode to the MS through a MOB-SLP-RSP message in response to the MOB-SLP-REQ message. Upon receiving the MOB-SLP-RSP message, the MS enters the sleep mode accordingly.

If it is determined that a traffic activity has been generated within a period of time, the MS performs a normal service procedure to process the generated traffic.

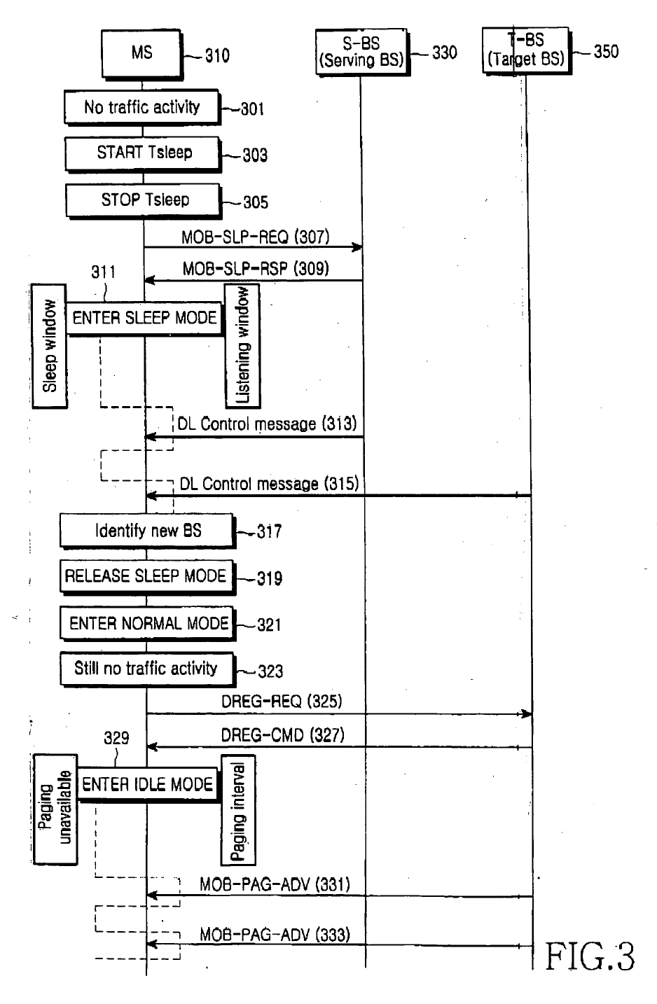

FIG. 3 is a diagram illustrating a signaling process between an MS and a BS in a wireless communication system according to the present invention.

Referring to FIG. 3, if no UL/DL traffic is generated, an MS 310 operates in a low-power mode, such as a sleep mode or an idle mode, to reduce power consumption in step 301. That is, if no UL/DL traffic is generated in step 301, the MS 310 starts a T sleep interval, or a first timer with a period of time T for entering the sleep mode in step 303. After a lapse of the period of time T, the MS 310 expires the first timer in step 305. Thereafter, the MS 310 transmits a MOB-SLP-REQ message for requesting its entry into the sleep mode, to a serving BS 330 in step 307.

Upon receiving the MOB-SLP-REQ message, the serving BS 330 transmits a MOB-SLP-RSP message to the MS 310 in response to the MOB-SLP-REQ message in step 309. That is, the serving BS 330 includes information indicating approval/denial for the state transition to the sleep mode, requested by the MS 310, in the MOB-SLP-RSP message before transmission. Upon receiving the MOB-SLP-RSP message from the serving BS 330, the MS 310 enters the sleep mode accordingly in step 311. That is, in step 311, the MS 310 analyzes a Sleep Approved value included in the MOB-SLP-RSP message, and makes a state transition to the sleep mode if the Sleep Approved value indicates approval for the state transition to the sleep mode.

Thereafter, the MS 310 repeatedly experiences the sleep window and the listening window for the sleep mode. In the meantime, the MS 310 receives a DL Control message from the serving BS 330 for the listening window in step 313. Then the MS 310 compares an FN and/or BS-ID information defined in a DL-MAP of the DL Control message with an expected FN calculated from an FN immediately before the transition to the sleep mode and/or BS-ID information, and holds the previous operation mode, such as the sleep mode, if the compared information is equal.

The MS 310 can leave the service area of the serving BS 300 and move to a service area of a target BS 350 for the sleep window. In this case, the MS 310 receives a DL Control message from the target BS 350 in a listening window succeeding the corresponding sleep window in step 315 as shown by a dotted line, as it moves from the service area of the serving BS 330 to the service area of the target BS 350.

Then the MS 310 compares an FN and/or BS-ID information defined in a DL-MAP received in the current listening window with an expected FN calculated according to a DL-MAP received in a previous listening window and/or BS-ID information. If an FN and/or BS-ID information for the current DL-MAP is different from an expected FN for the previous DL-MAP and/or BS-ID information, the MS 310 identifies a new BS, for example, the target BS 350 that transmitted the DL Control message, in step 317.

The MS 310 releases the sleep mode in step 319, recognizing through the foregoing process that it has moved to coverage of another BS for the sleep window. Subsequently, the MS 310 makes a state transition to the normal mode in step 321.

After the state transition to the normal mode, the MS 310 checks a DL/UL traffic activity in step 323 to determine whether any traffic activity has been generated for a period of time. If no traffic activity is generated for the period of time, the MS 310 operates in the idle mode to reduce power consumption. Therefore, if the DL/UL traffic activity is generated, the MS 310 starts a T-idle interval, or a second timer with a period of time T′ for entering the idle mode. After a lapse of time, such as the time T′, the MS 310 stops the second timer.

Preferably, the MS 310 checks the time T′ only when an FN and/or BS-ID information for the current DL-MAP is different from an expected FN for the previous DL-MAP and/or BS-ID information.

The MS 310 transmits a DREG-REQ message for requesting its entry into the idle mode to a corresponding BS, such as the target BS 350, in step 325, if no traffic activity is generated for a period of time. The MS 310 transmits the DREG-REQ message with a Paging Cycle value to the target BS 350.

Upon receiving the DREG-REQ message from the MS 310, the target BS 350 transmits a DREG-CMD message to the MS 310 in response to the DREG-REQ message in step 327. That is, the target BS 350 delivers information on an idle mode pattern that the MS 310 should use, to the corresponding MS 310 through the DREG-CMD message using a Paging Group ID, a Paging Cycle and a Paging Offset.

Upon receiving the DREG-CMD message from the target BS 350, the MS 310 makes a state transition to the idle mode and operates the idle mode based on the corresponding information included in the DREG-CMD message in step 329. Specifically, upon receiving the DREG-CMD message from the target BS 350, the MS 310 defines, as a paging interval, a number of frames, for example, five frames, in which an FN for a channel in sync with the current target BS 350, satisfies a condition, for example, FN/Paging Cycle=Paging Offset. Thereafter, the MS 310 receives a MOB-PAG-ADV message transmitted from the target BS 350 for the paging interval in step 331 or 333.

The MOB-PAG-ADV message includes a Paging Group ID to which a BS that transmits the MOB-PAG-ADV message, for example, the target BS 350 belongs, Medium Access Control (MAC) address Hash information indicating MSs that require location update or initial network entry among the MSs operating in the idle mode, and an Action Code describing a procedure that should be performed for each individual MS.

If a BS that transmits the DREG-CMD message before the MS enters the idle mode is different from a BS that transmits the current MOB-PAG-ADV message, in terms of the Paging Group ID, location update is performed or a series of procedures are performed according to an Action Code designated by a BS for each individual MS in the idle mode.

Although not illustrated in FIG. 3, if no traffic activity is generated for a period of time, the MS 310 can transmit a MOB-SLP-REQ message for entering the sleep mode other than the idle mode, to the target BS 350 in step 325. In this case, the MS 310 can enter the sleep mode according to the foregoing sleep mode procedure.

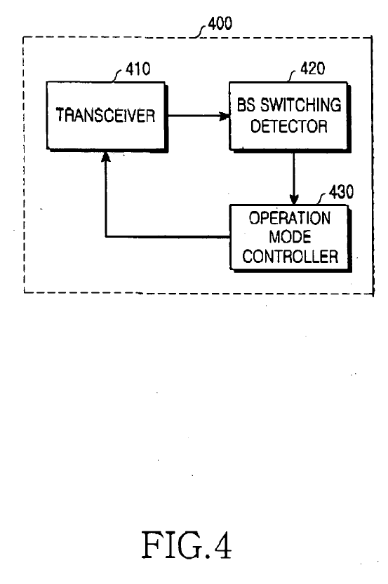

FIG. 4 is a block diagram schematically illustrating a structure of an MS according to the present invention.

Referring to FIG. 4, an MS 400 includes a transceiver 410, a BS switching detector 420 and an operation mode controller 430.

The MS 400 exchanges data with a particular BS through the transceiver 410. The transceiver 410 provides the BS switching detector 420 with a DL control message received from the BS in a listening window for the sleep mode. The BS switching detector 420, upon receiving the DL control message from the transceiver 410, compares an FN and/or BS-ID information defined in a DL-MAP of the current DL control message with an FN expected from an FN given immediately before a state transition to the sleep mode and/or known BS-ID information.

Alternatively, if the MS 400 is already operating in the sleep mode, the BS switching detector 420 compares an FN and/or BS-ID information defined in the current DL-MAP with an expected FN based on a DL-MAP received in a previous listening window and/or BS-ID information.

If an FN and/or BS-ID information for the current DL-MAP is different from the expected FN and/or known BS-ID information, the BS switching detector 420 identifies a switched new BS, recognizing that the MS 400 has switched the BS. In other words, the BS switching detector 420 determines that a serving BS of the MS 400 has been switched due to handover, and provides the corresponding information to the operation mode controller 430.

The operation mode controller 430, upon receiving the BS switching information from the BS switching detector 420, releases the current operation mode, such as the sleep mode, and then makes a state transition to the normal mode. Subsequently, the operation mode controller 430 checks a DL/UL traffic activity to determine whether any traffic activity has been generated for a period of time. If no traffic activity is generated for the period of time, the operation mode controller 430 transmits a DREG-REQ message with a Paging Cycle value to the BS, preparing for an entry into the idle mode. Alternatively, if no traffic activity is generated for the period of time, the operation mode controller 430 transmits a MOB-SLP-REQ message to the BS, preparing for an entry into the sleep mode.

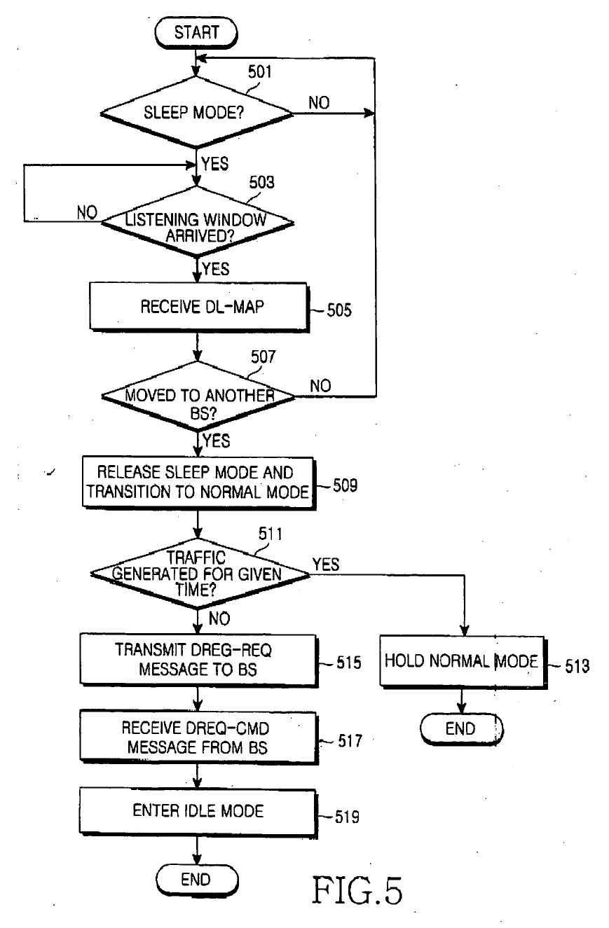

FIG. 5 is a flowchart illustrating a process of controlling an operation mode in a MS in a wireless communication system according to the present invention.

Referring to FIG. 5, an MS determines in step 501 whether to enter the sleep mode to reduce power consumption. Preferably, in step 501, if no UL/DL traffic is generated for a period of time, the MS starts a timer with a time T for entering the sleep mode, and stops the timer after a lapse of the time T for entering the sleep mode. After stopping the timer, the MS can request to enter the sleep mode.

Then, the MS transmits a MOB-SLP-REQ message for requesting entry into the sleep mode to a BS. Thereafter, the MS receives a MOB-SLP-RSP message from the corresponding BS in response to the MOB-SLP-REQ message. Subsequently, the MS checks a Sleep Approved value included in the received MOB-SLP-RSP message, and makes a state transition to the sleep mode if the Sleep Approved value indicates approval for the state transition to the sleep mode.

If the MS determines entrance into the sleep mode in step 501, it determines in step 503 whether a listening window has arrived. As described above, after the state transition to the sleep mode, the MS repeatedly experiences the sleep window and the listening window in the sleep mode. In the listening window, the MS can receive a DL control message from the corresponding BS.

That is, if it is determined in step 503 that the listening window for the sleep mode has arrived, the MS receives a DL control message from the BS in step 505. The DL control message includes a DL-MAP. Thereafter, the MS determines in step 507 whether it has moved to a service area of another BS, based on the DL-MAP included in the DL control message. Specifically, the MS determines whether it has moved to coverage of another BS, by comparing an FN and/or BS-ID information defined in a DL-MAP of the current DL control message with an expected FN calculated immediately before the state transition to the sleep mode and/or known BS-ID information.

If an FN and/or BS-ID information for the current DL-MAP is different from an expected FN and/or known BS-ID information, the MS determines that it has moved to a service area of another BS. After detecting the BS switching, the MS releases the sleep mode and makes a state transition to the normal mode in step 509.

After the state transition to the normal mode, the MS determines in step 511 whether any traffic has been generated for a period of time. That is, the MS checks a UL/DL traffic activity to determine whether any UL/DL traffic has been generated for the period of time. Preferably, if no traffic activity is generated for the period of time, the MS operates in the idle mode to reduce power consumption. Therefore, if no DL/UL traffic activity is generated, the MS starts a timer with a time T′ for entering the idle mode. After a lapse of the time T′ for entering the idle mode, the MS stops the timer. After stopping the timer, the MS can request to enter the idle mode.

At this moment, the MS transmits a DREG-REQ message for requesting entry into the idle mode to the BS in order to enter the idle mode. Thereafter, the MS receives a DREG-CMD message from the corresponding BS in response to the DREG-REQ message. Subsequently, the MS makes a state transition to the idle mode according to information on an idle mode pattern included in the received DREG-CMD message.

That is, if it is determined in step 511 that any traffic is generated, the MS holds the normal mode in step 513. However, if no traffic activity is generated for a period of time, the MS transmits a DREG-REQ message with a Paging Cycle value to the BS in step 515. Thereafter, the MS receives a DREG-CMD message from the corresponding BS in response to the DREG-REQ message in step 517, and enters the idle mode in step 519.

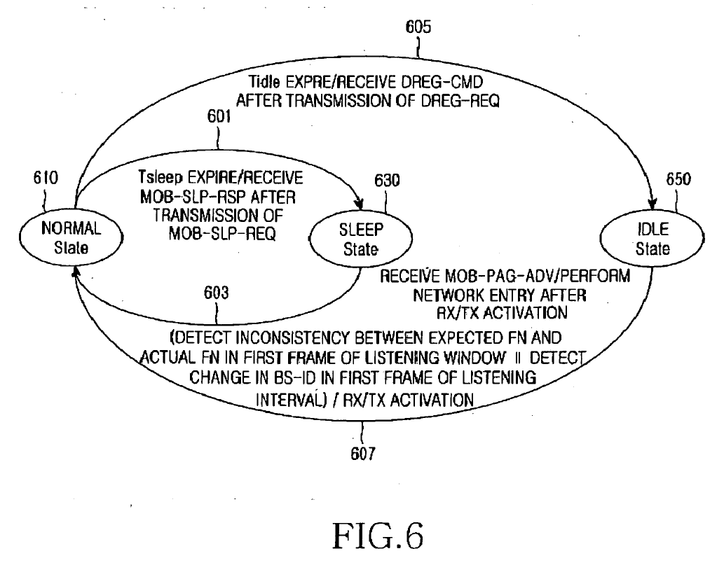

FIG. 6 is a diagram illustrating a state transition process of an MS in a wireless communication system according to the present invention.

Referring to FIG. 6, if a Tsleep interval expires in a normal state 610, an MS transmits a MOB-SLP-REQ message. Thereafter, upon receiving a MOB-SLP-RSP message in response to the MOB-SLP-REQ message, the MS transitions to a sleep state 630 in step 601. Preferably, the MOB-SLP-RSP message can include a Sleep Approved value, such as Sleep Approved=1 information, indicating approval for the state transition to the sleep mode.

If a Tidle interval expires in the normal state 610, the MS transmits a DREG-REQ message. Thereafter, upon receiving a DREG-CMD message in response to the DREG-REQ message, the MS transitions to an idle state 650 in step 605. Preferably, the DREG-CMD can include an Action Code value, such as Action Code=0x5 information, for an operation of the idle mode.

Thereafter, if the MS detects inconsistency between an expected FN and an actual FN in a first frame of a listening window and/or a change in BS ID in the first frame of the listening window in the sleep state 630, the MS activates transmission/reception of packet data and then transitions to the normal state 610 in step 603.

Thereafter, upon receiving a MOB-PAG-ADV message in the idle state 650, the MS performs a network entry procedure after activating data transmission/reception, and then transitions to the normal state 610 in step 607. Preferably, the MOB-PAG-ADV message can include an Action Code value, such as Action Code=10 information, for the procedure that should be performed for each individual MS.

As described above, the present invention can efficiently reduce power consumption of an MS in a wireless communication system, using a condition for state transition from the sleep mode to the idle mode and an operation mode transition scheme based thereon.

As can be understood from the foregoing description, an operation mode transition method and apparatus in a wireless communication system according to the present invention can efficiently reduce power consumption of an MS. In addition, according to the present invention, an MS can efficiently adaptively make a state transition from the sleep mode to the idle mode according to a system condition. Further, the present invention definitely an indefinite time for entering each operation mode, thereby efficiently implementing an operation mode procedure of an MS.

Moreover, if there is no UL/DL traffic activity, an MS with mobility can efficiently make a state transition to the idle mode for system resources and power saving. Also, if there is no UL/DL traffic activity, an MS with no mobility can make a state transition to the sleep mode for fast termination service. As a result, the present invention can simultaneously support the sleep mode and the idle mode through correlation between operation modes of an MS and flexible switching therebetween.

While the invention has been shown and described with reference to preferred embodiments thereof, it will be understood by those skilled in the art that various changes in form and details may be made therein without departing from the spirit and scope of the invention as defined by the appended claims.

What is claimed is:

1. A method for reducing power consumption of a mobile station (MS) in a wireless communication system, the method comprising the steps of:
(a) transmitting a request message for state transition to a corresponding operation mode to a base station (BS) with which the MS is currently communicating, if a period of time for state transition from a normal mode to a sleep mode or an idle mode expires;
(b) performing a state transition to the sleep mode or the idle mode upon receiving a response message from the BS;
(c) performing a state transition to the normal mode upon detecting a change in service area in the sleep mode; and
(d) performing a state transition to the normal mode upon receiving a paging advertisement message from a corresponding BS in the idle mode.

2. The method of claim 1, wherein step (a) comprises:
if a first time for state transition from the normal mode to the sleep mode expires, transmitting a sleep request message to the BS; and
if a second time for state transition from the normal mode to the idle mode expires, transmitting a de-registration request message to the BS.

3. The method of claim 1, wherein step (b) comprises:
receiving a sleep response message from the BS in response to the sleep request message; and
performing a state transition to the sleep mode according to the received sleep response message.

4. The method of claim 1, wherein step (b) comprises:
receiving a de-registration command message from the BS in response to the request message; and
performing a state transition to the idle mode according to the received de-registration command message.

5. The method of claim 1, wherein step (c) comprises:
receiving a control message from the BS in the sleep mode;
comparing first information defined in the control message with second information expected immediately before the state transition to the sleep mode; and
detecting a change in service area of the BS according to a comparison result between the first information and the second information.

6. The method of claim 5, wherein the control message includes a downlink control message including a downlink MAP (DL-MAP).

7. The method of claim 5, wherein the first information includes at least one of a frame number and a base station identifier defined in the control message.

8. The method of claim 5, wherein the second information includes an expected frame number calculated immediately before the state transition to the sleep mode or a base station identifier.

9. The method of claim 1, further comprising:
(e) releasing a current operation mode and performing a state transition to the normal mode upon detecting a change in service area;
(f) checking whether any traffic is generated in the normal mode for a period of time;
(g) performing a state transition to the idle mode if no traffic is generated for the period of time; and
(h) holding the normal mode if there is any traffic generated within the period of time.

10. The method of claim 9, wherein step (g) comprises:
starting a timer preset in the system for the state transition to the idle mode, if no traffic is generated for the period of time;
stopping the timer after a lapse of a time preset for the timer;
sending to the BS a request for the state transition to the idle mode; and
performing a state transition to the idle mode according to idle mode pattern information included in a response message received from the BS.

11. The method of claim 9, further comprising:
sending to the BS a request for the state transition to the sleep mode if no traffic is generated for the period of time; and
performing a state transition to the sleep mode according to a sleep-approved value included in the response message received from the BS.

12. An apparatus for controlling an operation mode of a mobile station (MS) in a wireless communication system, the apparatus comprising:
a base station (BS) switching detector for receiving a control message from a particular BS in a listening window for a sleep mode, and detecting whether a BS's service area of the MS is switched, based on the control message; and
an operation mode controller for checking whether any traffic is generated after performing a state transition from the sleep mode to a normal mode according to a result of the BS switching detection, and performing a state transition to an idle mode or the sleep mode if no traffic is generated for a period of time.

13. The apparatus of claim 12, wherein the operation mode controller transmits a de-registration request (DREG-REQ) message to the BS and receives a de-registration command (DREG-CMD) message from the BS to control the state transition to the idle mode.

14. The apparatus of claim 12, wherein the BS switching detector compares a frame number and/or base station identifier (BS-ID) information included in the control message with a frame number expected before the state transition to the sleep mode and/or known BS-ID information, and detects whether a BS's service area of the MS is switched, based on a result of the comparison.

15. The apparatus of claim 12, wherein the control message includes a downlink control message transmitted from the BS, the downlink control message including a downlink MAP (DL-MAP).

16. The apparatus of claim 12, wherein the operation mode controller checks an uplink/downlink traffic activity to determine whether any traffic is generated.

17. A method for performing a transition of an operation mode in a mobile station (MS) in a wireless communication system, the method comprising the steps of:
(a) detecting whether a service area is switched, based on a control message received in a listening window for a sleep mode;
(b) performing a state transition to a normal mode after releasing the sleep mode if the service area is switched; and
(c) performing a state transition to an idle mode or the sleep mode if no traffic is generated in the normal mode for a period of time.

18. The method of claim 17, wherein step (c) comprises:
transmitting to a particular base station (BS) a de-registration request (DREG-REQ) message for requesting a state transition to the idle mode;
receiving a de-registration command (DREG-CMD) message from the BS in response to the DREG-REQ message; and
performing a state transition to the idle mode according to idle mode pattern information included in the DREG-CMD message.

19. The method of claim 17, wherein step (a) comprises comparing a frame number and/or base station identifier (BS-ID) information included in the control message with an expected frame number and/or known BS-ID information.

20. The method of claim 17, wherein the control message includes a downlink control message transmitted from the BS, the downlink control message including a downlink MAP (DL-MAP).

21. The method of claim 17, wherein step (c) comprises checking an uplink/downlink traffic activity to determine whether any traffic is generated.

22. A method for reducing power consumption of a mobile station (MS) in a wireless communication system, the method comprising the steps of:
(a) receiving a downlink MAP (DL-MAP) from a particular base station (BS);
(b) performing a state transition to a normal mode after releasing a current mode if the MS determines that it has moved to coverage of another BS; and
(c) entering a low-power mode if no traffic is generated in the normal mode for a period of time.

23. The method for claim 22, wherein the DL-MAP is received in a first listening interval for a sleep mode.

24. The method of claim 22, wherein the low-power mode includes one of an idle mode and the sleep mode.

25. The method of claim 22, wherein step (c) comprises entering the idle mode based on a de-registration command (DREG-CMD) message received from a BS.

26. The method of claim 22, wherein step (b) comprises comparing a frame number and/or base station identifier (BS-ID) information of the received DL-MAP with an expected frame number and/or known BS-ID information, to detect movement of the MS.

27. An apparatus for reducing power consumption of a mobile station (MS) in a wireless communication system, the apparatus comprising:
a receiver for receiving a downlink MAP (DL-MAP) transmitted from a particular base station (BS); and
a controller for performing a state transition to a normal mode after releasing a current mode if the MS determines from the DL-MAP that it has moved to coverage of another BS, and entering a low-power mode if no traffic is generated for a period of time.

28. The apparatus of claim 27, wherein the receiver receives the DL-MAP in a first listening interval for a sleep mode.

29. The apparatus of claim 27, wherein the low-power mode includes an idle mode or the sleep mode.

30. The apparatus of claim 29, wherein the controller enters the idle mode based on a de-registration command (DREG-CMD) message received from the BS.

31. The apparatus of claim 27, wherein the controller compares a frame number and/or base station identifier (BS-ID) information of the received DL-MAP with an expected frame number and/or known BS-ID information, to detect movement of the MS.
